(19) United States
(12) Patent Application Publication
(10) Pub. No.: US 2026/0091996 A1
(43) Pub. Date: Apr. 2, 2026

(54) METHOD FOR LIQUID-SOLID SEPARATION

(71) Applicant: KEMIRA OYJ, Helsinki (FI)

(72) Inventors: Jonni AHLGREN, Espoo (FI); Jaakko HILTUNEN, Helsinki (FI)

(21) Appl. No.: 19/113,671

(22) PCT Filed: Sep. 19, 2023
(86) PCT No.: PCT/FI2023/050532

§ 371 Date: Mar. 20, 2025

(30) Foreign Application Priority Data
Sep. 20, 2022 (FI) 20225812

(51) Int. Cl. C02F 1/56; C02F 1/38

(52) U.S. Cl. CPC C02F 1/56; C02F 1/38; C02F 2209/08; C02F 2209/09; C02F 2209/10; C02F 2209/11

(57) ABSTRACT

The invention relates to a method for flocculating solid particles in a liquid-solid separation process. The method comprises obtaining a suspension of solid particles suspended in a continuous aqueous phase, and obtaining cationized cellulose, which has a charge density of at least 1.5 meq/g dry, measured at pH 4, and a 2% salt viscosity of at least 50 mPas. The cationized cellulose is subjected at a process concentration to a process shear force in a high shear step, wherein the process shear force corresponds or is larger than a default shear force which produces an increase in the 2% salt viscosity of the cationized cellulose by at least a factor of 2. After the high shear step the cationized cellulose is brought into a contact with the suspension of solid particles and flocculating the solid particles; and the flocculated solid particles are separated from the continuous aqueous phase in a dewatering step.

The present invention relates to a method for flocculating solid particles in liquid-solid separation according to the preamble of the enclosed independent claim.

Many industrial processes comprise a liquid-solid separation step, where solid particles are separated from a liquid phase. Usually a suspension of solid material suspended in an aqueous continuous phase is subjected to the liquid-solid separation, for providing a solid fraction and a liquid fraction that can be processed further. For example, liquid-solid separation steps are employed in water treatment processes, in manufacture of pulp, paper, board or the like, as well as in mining industry. One typical example of a liquid-solid separation step is sludge dewatering in any water treatment process. The sludge usually comprises various solid particles and/or microorganisms suspended in an aqueous phase. In a liquid-solid separation step the water content of the sludge is reduced so that the solid fraction of the sludge can be processed further, for example deposited, used as a fertilizer, or incinerated for energy production.

Often liquid-solid separation step includes flocculation of the solid particles suspended in a liquid phase. Flocculating and/or coagulating chemicals are used to improve the formation and/or the quality of the formed flocs. For example, in a water treatment process the sludge may be conditioned before the dewatering step by addition of flocculating agents, such as inorganic compounds of iron and lime, or synthetic organic polymers. These flocculating agents are added to the sludge in order to improve the sludge handling and to increase the dewatering effect in the liquid-solid separation.

Cationic polymers are conventionally used as flocculants in liquid-solid separation. Cationic polymers used as flocculants are usually petroleum-based synthetic polymers. Due to the non-degradable nature of the synthetic polymers, it may become impossible to use the separated solid fraction obtained from waste water treatment for landfills, composting, or for soil improvement, when synthetic cationic polymers have been employed in the liquid-solid separation step. Furthermore, there is a current growing incentive towards more sustainable industrial processes and towards bio-based and/or biodegradable chemicals. This desire to use bio-based and/or biodegradable chemicals has induced a strong interest to find replacements for petroleum-based synthetic cationic polymers. An interesting alternative is cationized cellulose, as cellulose itself is abundantly available, renewable and biodegradable. Cationized celluloses and cationized cellulose derivatives have been tested as flocculants for example in wastewater treatment, as described in Sievänen et al., Cellulose (2015), 22, 1861-1872. However, there is still a need to find new methods for improving the flocculation efficiency in the liquid-solid separation processes.

An object of this invention is to minimise or even eliminate the disadvantages existing in the prior art.

An object is also to provide a more sustainable method for flocculation in a liquid-solid separation process, especially for sludge dewatering in a water treatment process.

A further object of the invention is to provide a method which provides an effective flocculation and a high solids content for the separated solids after the liquid-solid separation step.

These objects are attained with the invention having the characteristics presented below in the characterising part of the independent claim. Some preferable embodiments are disclosed in the dependent claims.

The embodiments mentioned in this text relate, where applicable, to all aspects of the invention, even if this is not always separately mentioned.

A typical method according to the present invention for flocculating solid particles in a liquid-solid separation process, comprises
obtaining cationized cellulose, which has a charge density of at least 1.5 meq/g dry, measured at pH 4, and a 2% salt viscosity of at least 50 mPas;
subjecting the cationized cellulose at a process concentration to a process shear force in a high shear step, wherein the process shear force corresponds or is larger than a default shear force which produces an increase in the 2% salt viscosity of the cationized cellulose by at least a factor of 2;
after the high shear step bringing the cationized cellulose into a contact with a suspension of solid particles suspended in a continuous aqueous phase, and flocculating the solid particles; and
separating the flocculated solid particles from the continuous aqueous phase in a dewatering step.

Now it has been surprisingly found out that when a solution of cationized cellulose having a charge density of at least 1.5 meq/g is subjected to an appropriate process shear force, the flocculating ability of the cationized cellulose is improved in unexpected manner. This improvement in flocculating ability may be manifested by a high solid content after liquid-solid separation, short dewatering time and/or improved floc properties, e.g. floc strength, providing in general more effective liquid-solid separation. The theoretical background of the observed phenomenon is not yet fully understood, but it is speculated that the shear force might open the structure of the dissolved cationized cellulose and influence its interactions with the solid particles during flocculation.

The high shear step is an important feature of the present invention. The cationized cellulose, in solution form, should be subjected to an appropriate process shear force in the high shear step. It has been found out that appropriate process shear force corresponds the default shear force which produces an increase in 2% salt viscosity at least by a factor of 2. In the present context the term “2% salt viscosity” means the apparent viscosity value measured in an aqueous system consisting of 1.8 weight-% concentration of dissolved or dispersed cationized cellulose, water, and 9.1 weight-% of dissolved NaCl, at 25° C. The salt viscosity values are measured by using Brookfield LV viscometer with a small sample adapter, spindle #18 or #31, using the maximum possible rotational speed. The factor is calculated by dividing the 2% salt viscosity value for a cationized cellulose solution after the high shear treatment with the 2% salt viscosity value for the same cationized cellulose solution right after dissolution of the cationized cellulose, without high shear treatment. It is assumed that the increase in 2% salt viscosity value reflects the changes in the three-dimensional structure of the cationized cellulose in the solution, thus providing a reliable parameter for determining the appropriate shear force required. The conditions for producing appropriate shear force are defined in such a way that when they are applied to the cationized cellulose solution, the 2% salt viscosity of the cationized cellulose solution is at least two times the 2% salt viscosity of the same cationized cellulose solution without high shear treatment. When appropriate shearing conditions have been identified, they can be applied to cationized cellulose solutions at any concentration.

According to one preferable embodiment of the invention the cationized cellulose solution may be subjected in the high shear step to the process shear force which corresponds the default shear force which produces the increase in the 2% salt viscosity by the factor of 2-50, preferably 2-40, more preferably 2-23 or 5-30.

The cationized cellulose solution, at the process concentration, may be subjected to the process shear force in any suitable high-shear apparatus or high-shear device, which is able to create appropriate process shear force in an aqueous system. Preferably the cationized cellulose is subjected to the process shear force in a high shear step, performed at atmospheric pressure (101.3 kPa). For example, the cationized cellulose solution may be subjected to the process shear force in a homogenizer, a high-speed mixer, a disperser, a rotor-stator mixer, a mixer with two counterrotating rotors, centrifugal pumping device providing a straight flow or back rotation flow, shear pumps or the like. In some cases also ultrasonic treatment is applicable. Suitable high shear mixing apparatuses and homogenizers are well-known for a person skilled in the art and commercially available, for example under tradenames Ultra Turrax®, Polytron®, Atrex®, Silverson®, Ystral®, Cavitron™ and Waukesha shear Pumps™. For example, the cationized cellulose may be dissolved in water, whereafter the obtained cellulose solution is subjected to the process shear force by high-shear homogenisation and then the cellulose solution is brought into contact with the aqueous suspension comprising solid particles to be flocculated. The high-shear homogenisation may be achieved, for example, by using rotational speed of at least 2000 rpm. The homogenisation is preferably performed as mechanical homogenisation without using pressure differences, for example in a homogenizer using rotor-stator principle. The appropriate process shear force may be achieved also in a shear step where the cationized cellulose solution is subjected to process shear force by centrifugal pumps or the like, e.g. during pumping of the cationized cellulose after it has been dissolved or dispersed in water.

The solution of cationized cellulose is subjected to process shear force before the cationized cellulose solution is brought into contact with the suspension to be flocculated in order to fully utilize the improved flocculation effect. After the high shear step, where the cationized cellulose solution has been subjected to the process shear force, the cationized cellulose solution is brought into the contact with the aqueous suspension comprising solid particles. The solid particles suspended in a continuous aqueous liquid phase of the suspension are flocculated. The flocculated solid particles are then separated from the continuous aqueous phase of the suspension in a dewatering step. The separation of the flocculated solid particles may be performed for example by using gravity sedimentation, filtering, pressing or centrifugal force. Various mechanical dewatering means, such as centrifuge(s), belt press or chamber press, preferably centrifuge(s), can be employed for separation of the aqueous phase from the formed flocs comprising the solid particles.

The cationized cellulose is obtained and used in the present invention in form of an aqueous solution. The cationic cellulose is in form of a solution both before and after the high-shear step, and free from gel formation. The cationized cellulose solution may be obtained in a suitable process concentration or it may be diluted to a suitable process concentration before the high shear step. If the cationized cellulose is originally in form of solid particles, it is preferably dissolved in water and optionally diluted in order to obtain the cationized cellulose solution having the suitable process concentration. A suitable process concentration may be, for example, in a range of 0.1-5 weight-%, preferably 0.15-3 weight-%, more preferably 0.2-1 weight-%. In general, cationized cellulose suitable for use in the present invention is at least partly water-soluble. Preferably, the cationized cellulose is water-soluble.

In the present context, the term “water-soluble” denotes cationized cellulose which is fully miscible with water providing transparent or nearly transparent solution. When mixed with excess of water, the cationized cellulose is dissolved and the obtained solution of cationized cellulose is preferably essentially free from discrete solid particles, fibres, fibrils, granules or coagulated clots of cationized cellulose. Excess of water means that the obtained solution is not a saturated solution.

As the cationized cellulose suitable for use in the present invention is at least partly water-soluble or water-soluble, the high-shear step is preferably free from formation of fibrils, such as formation of nanocellulose or the like. Preferably, the high-shear step is performed in a manner that does not cause structural degradation or shortening of the cellulose molecules. Preferably, at least 70% or at least 80% or at least 90% of the cellulose molecules have the same structural length before and after the high-shear step. Instead, it is speculated that the high-shear step causes the structure of the dissolved cellulose molecule to open up or disentangle itself, whereby the cationic groups of the cationized cellulose are more available for interaction.

The cationized cellulose solution may have a 2% salt viscosity of at least 80 mPas, preferably at least 100 mPas, more preferably at least 150 mPas, when measured before the high shear treatment. According to one embodiment the 2% salt viscosity of the cationized cellulose solution may be in a range of 80-10 000 mPas, preferably 100-10 000 mPas, more preferably 150-6000 mPas, even more preferably 200-2500 mPas, measured before the high shear treatment.

According to one preferable embodiment the method for flocculating solid particles in a liquid-solid separation process comprises
obtaining a suspension of solid particles suspended in a continuous aqueous phase;
obtaining cationized cellulose, which has a charge density of at least 1.5 meq/g dry, measured at pH 4, and a 2% salt viscosity of at least 50 mPas;
subjecting the cationized cellulose at a process concentration to a process shear force in a high shear step, wherein the process shear force corresponds or is larger than a default shear force which produces an increase in the 2% salt viscosity of the cationized cellulose by at least a factor of 2;
after the high shear step bringing the cationized cellulose into a contact with the suspension of solid particles and flocculating the solid particles; and
separating the flocculated solid particles from the continuous aqueous phase in a dewatering step.

The cationized cellulose suitable for use in the present invention has a charge density of at least 1.5 meq/g dry, measured at pH 4. The charge density values are given per gram cationized cellulose material as dry, and determined at pH 4 by using particle charge titrator (AFG Analytic GmbH, Germany). According to one preferred embodiment the cationized cellulose may have the charge density of at least 1.75 meq/g dry, preferably at least 2 meq/g dry. According to one embodiment the charge density of the cationized cellulose may be in the range of 1.5-4 meq/g dry, preferably 1.75-3.75 meq/g dry, more preferably 2-3.5 meq/g dry. It is assumed that the high charge density of the cationized cellulose produces strong interaction with the solid particles of the suspension, especially after the high shear step. The high charge density of the water-soluble cationized cellulose may also improve the strength of the formed flocs, which are able to resist floc breaking forces even in demanding environment, e.g. during dewatering by centrifuging. This improves the results of liquid-solid separation.

According to one embodiment the cationized cellulose may have a degree of substitution DS of at least 0.32, preferably at least 0.37, sometimes even at least 0.4 or at least 0.5. The degree of substitution may be in a range of 0.32-1.75, preferably 0.37-1.6, more preferably 0.4-1.5 or 0.5-1.3. According to one embodiment the degree of substitution is at least 0.6, at least 0.7 or at least 0.8, for example in a range of 0.6-1.75, 0.7-1.6, or 0.8-1.5. The degree of substitution can be calculated on basis of the measured charge density value for the obtained cationized cellulose. The degree of substitution provides an estimate of the number of cationic groups per anhydroglucose units of the cellulose. It is assumed that the high degree of substitution increases the water-solubility of the cationized cellulose and makes it more suitable for shear treatment.

The charge density of the cationized cellulose is in general relative to the degree of substitution of the cationized cellulose material, and vice versa. An example of correspondence between the charge density and the calculated degree of substitution is given in Table 1.

TABLE 1
Charge density vs. calculated degree of substitution.

| Charge | |
|---|---|
| density | Calculated |
| meq/g | DS |
| 0.50 | 0.10 |
| 0.75 | 0.14 |
| 1.00 | 0.19 |
| 1.25 | 0.25 |
| 1.50 | 0.31 |
| 1.75 | 0.38 |
| 2.00 | 0.46 |
| 2.25 | 0.56 |
| 2.50 | 0.66 |
| 2.75 | 0.77 |
| 3.00 | 0.90 |
| 3.25 | 1.04 |
| 3.50 | 1.21 |
| 3.75 | 1.41 |
| 4.00 | 1.66 |

The cationized cellulose which is suitable for use as a flocculating agent in the present invention may have turbidity less than 1000 NTU, preferably less than 500 NTU, more preferably less than 250 NTU, especially when the cationized cellulose originated from cellulosic pulp. The turbidity may be, for example, 40-1000 NTU, 40-500 NTU or 40-250 NTU. The turbidity values are measured from cationized cellulose water solution, at 1 weight-% concentration, by using HACH, 2100 AN IS Laboratory Turbidimeter. The low turbidity values of the cationized cellulose solution indicate that the cationized cellulose at the process concentration is almost fully or fully water-soluble. Preferably, the turbidity value for the cationized cellulose remains essentially unchanged before and after high shear treatment.

Cationized cellulose may be obtained by any method producing water-soluble cellulose with sufficient cationicity. One possible way to prepare cationized cellulose is disclosed in PCT/FI2020/050817. According to this preferable embodiment, the cationized cellulose may be obtained by preparing a reaction slurry by mixing a cellulosic starting material with an alkaline liquid medium comprising an organic liquid, wherein the concentration of the cellulosic starting material in the reaction slurry being at least 20 weight-%. Alkaline liquid comprises at least one alkaline agent, at least one organic liquid and water. The alkaline agent may be selected from a group consisting of alkali hydroxides, such as NaOH, LiOH or KOH; alkali carbonates, such as Na₂CO₃ or K₂CO₃; ammonium hydroxide; quaternary ammonium hydroxides and tetramethyl guanidine. The amount of alkaline agent, such as NaOH, may be in a range of 7-18 weight-%, for example 7.5-15 weight-%, calculated from the total weight of the slurry. The organic liquid may be selected from a group consisting of secondary or tertiary alcohols, such as isopropanol, tert-butanol, sec-butanol, or any of their mixtures, preferably isopropanol or is isopropanol. The amount of organic liquid may be in a range of 30-55 weight-%, preferably 35-50 weight-%, more preferably 40-45 weight-%, calculated from the total weight of the slurry. After a mercerization step at a mercerization temperature from −15° C. to +20° C., preferably from −10° C. to +10° C., more preferably from −5° C. to +5° C., a cationizing agent is added to the reaction slurry, preferably under inert atmosphere, and allowed to interact with the cellulose. The cationization agent may be selected from (3-chloro-2-hydroxypropyl)trimethylammonium chloride (CHPTAC), glycidyltrimethylammonium chloride (GTAC) or any mixtures thereof. The reaction temperature during the cationization step may be <100° C., preferably in a range of 35-80° C., more preferably 40-60° C.

Cationized cellulose may be produced from any cellulosic starting material selected from wood or other cellulose containing biomass. Cationized cellulose may be produced from cellulosic starting material selected from wood or wood-based cellulosic materials, which may originate from hardwood or softwood or their mixtures, or from cellulose-containing biomass, such as cotton, or from cellulose-containing plant residues from agriculture and/or harvesting.

The present invention is suitable for flocculating solid particles in any liquid-solid separation process where solid particles are separated from an aqueous liquid phase. For example, the present invention is especially suitable for treating wastewater, preferably municipal wastewater or industrial wastewater or for conditioning drinking water. According to one preferable embodiment the liquid-solid separation process may be a sludge dewatering step of a water treatment process, for example, of municipal wastewater treatment process or industrial wastewater treatment process. The aqueous suspension to be dewatered may be municipal wastewater sludge or agricultural sludge, or it may originate from a biological treatment process of wastewater and/or sewage. Alternatively, the aqueous suspension may originate from an industrial process, especially from wastewater treatment of an industrial process, or from food or beverage production or from food or beverage processing.

The aqueous suspension comprises a continuous aqueous liquid phase and organic and/or inorganic solid material and/or particles suspended in the aqueous liquid phase. The suspension may be rich in material of bacterial origin, especially if it originates from a water treatment process. The aqueous liquid phase of the suspension may contain also dissolved organic substances, such as polysaccharides, humic substances and fatty acids. The suspension may have a biological oxygen demand (BOD)>50 mg/l, chemical oxygen demand (COD) in a range of 15-45 g/l, preferably 20-40 g/l, and/or a dry solids content in a range of 5-80 g/l, preferably 10-60 g/l, more preferably 20-55 g/l. pH of the suspension may be in a range from pH 6 to pH 9, preferably from pH 7 to pH 8. The conductivity of the suspension may be in a range of 5-14 mS/cm, preferably 5-10 mS/cm, and/or the charge density may be in a range from −5.5 to −1.5 μeq/g, preferably from −5.0 to −1.8 μeq/g. Total phosphorous value for the suspension may be in a range of 400-1400 mg/l, preferably 450-1200 mg/l and/or the total nitrogen value in a range of 1.2-3.5 g/l, preferably 1.5-3.0 g/l.

If the present invention is used in wastewater treatment process, especially in a sludge dewatering step, the cationized cellulose solution may be brought into a contact with the suspension in amount of 1-30 kg/ton dry suspension, preferably 2-20 kg/ton dry suspension, more preferably 3-15 kg/ton dry suspension.

According to one embodiment of the invention may be used to improve the liquid-solid separation process, such as initial dewatering step, in a paper or board manufacture. The cationized cellulose solution may be used as a retention enhancer agent or as a fixing agent, and it can be added to pulp or fibre stock in order to flocculate at least some of the solid components of the pulp or fibre stock. For example, the cationized cellulose may be able attach and/or associate the hydrophobic substances onto the fibres and thus to the cellulosic fibre web, thereby reducing the accumulation and deposition of hydrophobic substances in the process surfaces and/or waters.

In the present context the term “hydrophobic substances” encompasses all hydrophobic interfering substances present in manufacture of paper, board or the like, including stickies and pitch, which potentially cause deposits. The term “stickies” denotes synthetic hydrophobic substances originating e.g. from adhesives, printing inks, coating binders, such as synthetic latices, waxes, and hydrophobic internal and surface sizing agents. The term “pitch” denotes natural hydrophobic substances and wood extractives, such as terpenoids, sterols, stearyl esters, fatty acids and their esters, resin acids and their esters, including their salts and other forms thereof.

According to one embodiment the after the high shear step the cationized cellulose solution may be added to the thick fibre stock comprising cellulosic fibres. In the context of this application thick fibre stock is understood as a fibrous stock, which has a fibre consistency of at least 10 g/l, preferably at least 20 g/l, more preferably at least 30 g/l. The fibre consistency may be in a range of 10-60 g/l, preferably 20-50 g/l, more preferably 30-40 g/l. The cationized cellulose can be added to thick fibre stock in all conventional application locations, where fixatives and/or retention agents are typically applied to the stock. The addition of the cationized cellulose may be located after the stock storage tower(s), but before the thick fibre stock is diluted in the wire pit (off-machine silo) with short loop white water. According to one embodiment the cationized cellulose may be dosed to the thick stock in amount of 100-2000 g/ton, typically 200-1500 g/ton, more typically 500-1500 g/ton, given per ton produced fibre web as dry.

### EXPERIMENTAL

Some non-limiting embodiments of the present invention are disclosed in the following examples.

### Example 1: Preparation of Cationized Cellulose

High-molecular weight dissolving pulp, refined to 30° SR, was used as raw material. The pulp was pre-dried to dry content of 90.6% weight-% in a 6 litre Lödige DVT 5 reactor, equipped with mechanical mixers and temperature control jacket. The temperature in the jacket was set to 105° C. using a thermostat bath circulating the warming/cooling medium liquid.

Sodium hydroxide solution and isopropanol (IPA) were cooled down in fridge at least overnight. 347 g of pre-dried dissolving pulp at dry content 90.6 weight-% (314 g as dry cellulose) was added into a Lödige reactor. The temperature of the reactor jacket was set to 0° C. 275 g of 40 weight-% sodium hydroxide solution and 376 g of isopropanol were mixed together before adding into the reactor. The reaction mixture was mixed 21.3 h, 100 rpm, temperature 0° C.

Solution of (3-chloro-2-hydroxypropyl)trimethylammonium chloride solution (CHPTAC, Sigma-Aldrich, 60 weight-% active) was cooled down in a fridge. 512 g of CHPTAC was weighed to a beaker and pumped at 1 l/h speed into the reactor containing an intermediate product from the preceding reaction with sodium hydroxide. During the CHPTAC feed the mixing was continued and the temperature in the reactor jacket was maintained at 10° C. At the end of feeding of CHPTAC, the temperature of the reactor jacket was increased to 60° C. After all the CHPTAC had been fed in, an additional dosage of 100 g isopropanol was pumped through the same tube at same speed to flush all CHPTAC into the reactor. After all solutions were in the reactor and temperature of the bath had reached 60° C., the lid of the reactor was closed and nitrogen flow to reactor was started at 1 l/min. Calculation of the reaction time was started at this point. The reaction was continued 23 hours.

When the reaction was finished, a part of the reaction mass was taken from the reactor for purification. The taken part of the reaction mass was dissolved in water in ratio 1:8 (reaction mass to water) and mixed with a magnetic stirrer for 15 min. After this the pH of the solution was decreased to pH 4.3-6.5 using 50 weight-% acetic acid. Then the solution was poured to isopropanol (IPA) in ratio of 1 g dissolved reaction mass to 50 ml IPA. The solution was filtered using black ribbon filter paper. The filtered cake was washed three times. In two first washing times washing liquid IPA/water 70/30 (by volume) was used. The last washing was made by using washing liquid IPA/water 80/20 (by volume). Washing was done by dispersing the filtered cake in the washing liquid in ratio ‘filtered cake to washing liquid’ of 1:10 for 15 min. The mixture was filtered using black ribbon filter paper. The last filtered cake was dried overnight at 60° C. The sample was named to Sample A.

The obtained cationized cellulose was characterized as follows.

### Charge Density

Charge density at pH 4 was determined using AFG Analytics' particle charge titrator. Cationized cellulose sample was dissolved as 0.025-0.05 weight-% solution in deionized water, pH was adjusted to 4.0 with 0.1 M acetic acid and titrated using 0.001 N sodium polyethylenesulfonate (PES-Na) solution as the titrant. During titration pH was normally increasing 0.1-0.2 pH units. Charge density is expressed as meq/g dry substance. The cationized cellulose Sample A had charge density 1.8 meq/g dry sample.

### 2% Salt Viscosity

2% salt viscosity of cationized cellulose solution in water in presence of salt was determined using Brookfield LV viscometer with a small sample adapter at 25° C., using spindle #18 or #31, depending on viscosity level. The 2% salt viscosity measurement is performed by using maximum possible rotational speed. The obtained cationized cellulose was first dissolved in deionized water as 2 weight-% solution. Then sodium chloride (NaCl) in weight ratio NaCl:cellulose of 5:1 was added and let to dissolve under mixing before the salt viscosity was measured. This means that the salt viscosity of the cationized cellulose is measured at 1.8 weight-% concentration of cationized cellulose in an aqueous solution comprising 9.1 weight-% of NaCl. The cationized cellulose Sample A had a 2% salt viscosity of 5700 mPas.

### Conductivity

Conductivity of 0.5 weight-% cationized cellulose in deionized water was measured using Knick SE 204 sensor. The cationized cellulose Sample A had conductivity of 0.51 mS/cm.

### High Shear Treatment

High shear treatment was applied by mixing cationized cellulose solution using Ultra-Turrax IKA T 25 D homogenizer with blade S 25 N-25 F at 16000 rpm 3-4 minutes, until the solution became slightly warmed. To define the factor for the viscosity increase measured as 2% salt viscosity, the high shear treatment was made at 2 weight-% concentration. These conditions were then used for high shear treatment at process concentrations of the Examples.

### Application Example 2: Sludge Dewatering

Sludge dewatering tests were carried out by using capillary suction time (CST) test, by using Triton type 319 Multi-purpose CST (Triton Electronics Ltd, UK) with a type 317 Stirrer-Timer (Triton Electronics Ltd, UK).

In the CST test the mixing speed was 1000 rpm. Cylinder used had diameter 18 mm. Cationized cellulose was added as 0.2 weight-% solution to 100 g of the digested sludge, and mixed 10 s after addition. After 10 s mixing a 4.5 ml sample was taken to the cylinder and the CST value was measured.

Digested sludge was collected from a Finnish wastewater treatment plant. The sludge was diluted with tap water to dry content 3.1% before CST tests. Without any chemical additions the sludge gave a CST time of 452 s.

Cationized cellulose Sample A from Example 1 was used in the experiments. Cationized cellulose was used (1) as such after dissolution, or (2) after high shear treatment. 2% salt viscosity of cationized cellulose Sample A was (1) 5700 mPas, as such after dissolution; and (2) 84000 mPas, after the high shear treatment. Thus the salt viscosity of the cationized cellulose increased by factor of 14.7.

The CST results are shown in Table 1. High shear treated sample is indicated with “+UT”. For the CST tests the high shear treatment was made at 0.2 weight-% concentration.

The results of Table 1 show clearly that high shear treatment of the cationized cellulose improves dewatering performance.

TABLE 1
CST time results (s) for Application Example 2.

| Dosage | | Sample |
|---|---|---|
| [kg/t]* | Sample A | A +UT |
| 6 | 29.3 | 17.4 |
| 10 | 15.3 | 12 |
| 14 | 11 | 9.9 |
| 18 | 9.3 | 9.1 |

*given as kg per ton of dry sludge

### Application Example 3: Sludge Dewatering

Various cationized celluloses were prepared from different cellulose starting materials using the same principle as described in Example 1. When the cationized celluloses were subjected to high shear treatment in the same manner as in Application Example 2, their viscosities increased considerably, which is seen as increase in their 2% salt viscosity values. The starting materials and properties of the cationized celluloses are given in Table 2. The properties are determined in the manner described in Example 1.

TABLE 2
Cationized celluloses used in Application Example 3.

| | | | | | 2% Salt | |
|---|---|---|---|---|---|---|
| | | | | 2% Salt | Vis- | |
| | | Conduc- | Charge | Vis- | cosity | |
| Sam- | Starting | tivity | density | cosity | After UT* | Fac- |
| ple | material | [mS/cm] | [meq/g] | [mPas] | [mPas] | tor |
| Sam- | High molecular | 0.66 | 2.7 | 726 | 1515 | 2.1 |
| ple | weight | | | | | |
| C | dissolving pulp | | | | | |
| Sam- | High molecular | 0.54 | 2.0 | 4409 | >100000 | >22.7 |
| ple | weight | | | | | |
| D | dissolving pulp | | | | | |

*measured after high shear treatment

CST testing were made as described in Example 2. Digested sludge was collected from a Finnish wastewater treatment plant. The sludge was diluted with tap water to dry content 3.6% before CST tests. Without any chemical additions the sludge gave a CST time of 509 s.

The CST results are shown in Table 3. High shear treated sample is indicated with “+UT”. The results of Table 3 show clearly that high shear treatment improves performance of cationized celluloses in liquid-solid separation. At every dosage amount the CST time was lower for high shear treated cationized celluloses compared to corresponding cationized celluloses without high shear treatment.

TABLE 3
CST time results (s) for Application Example 3.

| Dosage | | Sample | | Sample |
|---|---|---|---|---|
| [kg/t]* | Sample C | C +UT | Sample D | D +UT |
| 8 | 34.4 | 26 | 37.2 | 22 |
| 12 | 14.8 | 13.3 | 17.3 | 13.6 |
| 16 | 10.8 | 9.9 | 10.5 | 10.5 |
| 20 | 9.1 | 8.7 | 10.8 | 9.9 |

*given as kg per ton of dry sludge

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. A method for flocculating solid particles in a liquid-solid separation process, the method comprising:
obtaining cationized cellulose, which has a charge density of at least 1.5 meq/g dry, measured at pH 4, and a 2% salt viscosity of at least 50 mPas;
subjecting the cationized cellulose at a process concentration to a process shear force in a high shear step, wherein the process shear force corresponds or is larger than a default shear force which produces an increase in the 2% salt viscosity of the cationized cellulose by at least a factor of 2;
after the high shear step, bringing the cationized cellulose into a contact with a suspension of solid particles suspended in a continuous aqueous phase and flocculating the solid particles; and
separating the flocculated solid particles from the continuous aqueous phase in a dewatering step.

2. The method according to claim 1, wherein the cationized cellulose is in the form of a solution.

3. The method according to claim 1, wherein the cationized cellulose is subjected in the high shear step to the process shear force which corresponds the default shear force which produces the increase in the 2% salt viscosity by the factor of 2-50, preferably 2-40, more preferably 5-30.

4. The method according to claim 1, wherein diluting the obtained cationized cellulose into the process concentration occurs before the high shear step.

5. The method according to claim 1, wherein the process concentration is in a range of 0.1-5 weight-%, preferably 0.15-3 weight-%, more preferably 0.2-1 weight-%.

6. The method according to claim 1, wherein the 2% salt viscosity of the cationized cellulose is at least 80 mPas, preferably at least 100 mPas, more preferably at least 150 mPas.

7. The method according to claim 1, wherein the cationized cellulose has a turbidity less than 1000 NTU, preferably less than 500 NTU, more preferably less than 250 NTU.

8. The method according to claim 1, wherein the cationized cellulose has a degree of substitution DS at least 0.32, preferably at least 0.37, more preferably at least 0.4.

9. The method according to claim 8, wherein the cationized cellulose has the degree of substitution DS in a range of 0.32-1.75, preferably 0.37-1.6, more preferably 0.4-1.5.

10. The method according to claim 1, wherein the cationized cellulose has the charge density in the range of 1.5-4 meq/g dry, preferably 1.75-3.75 meq/g dry, more preferably 2-3.5 meq/g dry.

11. The method according to claim 1, wherein the liquid-solid separation process is a treatment process of wastewater, preferably municipal wastewater or industrial wastewater.

12. The method according to claim 1, wherein the suspension has a biological oxygen demand (BOD)>50 mg/l, and/or a chemical oxygen demand (COD) in a range of 15-45 g/l, preferably 20-40 g/l, and/or a dry solids content in the range of 5-80 g/l, preferably 10-60 g/l, more preferably 20-55 g/l.

13. The method according to claim 1, wherein the cationized cellulose is brought into the contact with the suspension in amount of 1-30 kg/ton dry suspension, preferably 2-20 kg/ton dry suspension, more preferably 3-15 kg/ton dry suspension.

14. The method according to claim 1, wherein the cationized cellulose is subjected to the process shear force in a homogenizer, in a high-speed mixer, in a disperser, in a rotor-stator mixer, in a mixer with two counterrotating rotors, in a centrifugal pumping device providing a straight flow or back rotation flow, or in a shear pump.
